(19) United States
(12) Patent Application Publication
(10) Pub. No.: US 2022/0334581 A1
(43) Pub. Date: Oct. 20, 2022

(54) METHOD AND SYSTEM FOR AUTOMATED IMPLEMENT CONTROL

(71) Applicant: Caterpillar Paving Products Inc., Brooklyn Park, MN (US)

(72) Inventor: Nathaniel S. DOY, Maple Grove, MN (US)

(73) Assignee: Caterpillar Paving Products Inc., Brooklyn Park, MN (US)

(21) Appl. No.: 17/230,600

(22) Filed: Apr. 14, 2021

(51) Int. Cl. G05D 1/00; E02F 3/76; E02F 3/84; B60W 60/00; E02F 3/96; E01C 19/26

(52) U.S. Cl. CPC G05D 1/0094; E02F 3/7618; E02F 3/844; G05D 1/0011; B60W 60/0051; B60W 60/0025; E02F 3/961; E01C 19/264; B60W 2300/17; G05D 2201/0202; E01C 19/285

(57) ABSTRACT

A method for control of a compacting machine including a ground-engaging implement and a compacting drum includes receiving a request to activate the compacting machine, receiving a command to propel the compacting machine, and automatically generating a command to move the implement to a raised position in which the implement does not engage the ground based on: the request to activate the compacting machine, the command to propel the compacting machine, or a determination that the implement is below a threshold height. The method also includes, once the implement is in the raised position, propelling the compacting machine.

### TECHNICAL FIELD

The present disclosure relates generally to machines having ground-engaging devices, and more particularly, to machines configured for automated control of one or more machine functions.

### BACKGROUND

Machines such as compactors are complex and often involve multiple control systems and numerous inputs. While operator input systems are designed with the goal of reducing this complexity, controlling multiple aspects of the machine can be challenging in some circumstances, even for seasoned operators. Moreover, despite these design efforts, there are numerous tasks for which different combinations of inputs are required, further complicating control of the machine. For example, a soil compactor or similar machine may be equipped with a front blade that can be positioned to contact the ground (e.g., to facilitate grading), as well as a vibration mechanism for a drum, the blade and the vibration mechanism being independently operated and useful in different situations. While the inclusion of a blade increases functionality of the device, an operator interacting with such a compactor must remember to raise the blade when grading is not desired, to prevent inadvertently operating the machine with the blade in a lowered condition.

Complexity of machine control is further increased for machines that are configured for remote and/or autonomous operation. In the example of remote operation, an operator may have difficultly determining a position of a blade, especially when beginning operation of the machine. Similarly, autonomous operation of a machine, such as a compactor having a blade, can require the use of complicated control algorithms and precise monitoring of the position of each component of the machine. These additional design considerations can significantly increase the complexity and cost associated with autonomous machines, even for machines that, absent automation, are relatively uncomplicated.

Chinese utility model publication CN212335710U (the '710 publication) describes a compacting machine that includes a roller and a bulldozer-type blade. The compacting machine described in the '710 publication includes a hydraulic cylinder that is operated to raise and lower the blade. The compacting machine described in the '710 publication also includes a hydraulic mechanism for changing an orientation of the blade. While the compacting machine described in the '710 publication may be useful in situations where increased control over blade position is helpful, the machine may be unable to automatically lift the blade, which can cause the blade to unintentionally dig into the ground. Additionally, the compacting machine described in the '710 publication may be unable to facilitate autonomous or remote operation of the machine.

The disclosed method and system may solve one or more of the problems set forth above and/or other problems in the art. The scope of the current disclosure, however, is defined by the attached claims, and not by the ability to solve any specific problem.

### SUMMARY

In one aspect, a method for control of a compacting machine may include a ground-engaging implement and a compacting drum includes receiving a request to activate the compacting machine, receiving a command to propel the compacting machine, and automatically generating a command to move the implement to a raised position in which the implement does not engage the ground based on: the request to activate the compacting machine, the command to propel the compacting machine, or a determination that the implement is below a threshold height. The method may also include, once the implement is in the raised position, propelling the compacting machine.

In another aspect, a method for control of an earthmoving machine including an implement and a compacting drum may include receiving a request for the machine to perform a task, the request being: received from a remote system outside of the machine, a request for autonomous operation of the earthmoving machine, or both, and in response to the request, automatically generating a command to move the implement to a raised position in which the implement does not engage ground, the command being generated for a predetermined amount of time. The method may also include propelling the earthmoving machine, once the implement is above the ground.

In yet another aspect, a compacting machine may include a cabin, a compacting drum, a blade configured to be selectively positioned at a lowered position in which the blade is configured to engage material and a raised position above the material, and a controller. The controller may be configured to receive a command to propel the compacting machine, and automatically generate a command to move the blade to the raised position in which the blade does not engage ground based on: an activation of the compacting machine, the command to propel the compacting machine, or a determination that the blade is below a threshold height. The controller may also be configured to generate a command to propel the compacting machine in an autonomous mode or a remote operation mode once the implement is in the raised position.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a diagram illustrating a machine implement control system with a blade in a lowered position, according to an aspect of the present disclosure.

FIG. 2 is a diagram illustrating a machine implement control system with a blade in a raised position, according to an aspect of the present disclosure.

FIG. 3 is a block diagram illustrating an exemplary configuration of the machine implement control system of FIG. 1.

FIG. 4 is a flowchart illustrating an exemplary method according to an aspect of the present disclosure.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “substantially,” “generally,” and “approximately” are used to indicate a possible variation of ±10% in the stated value.

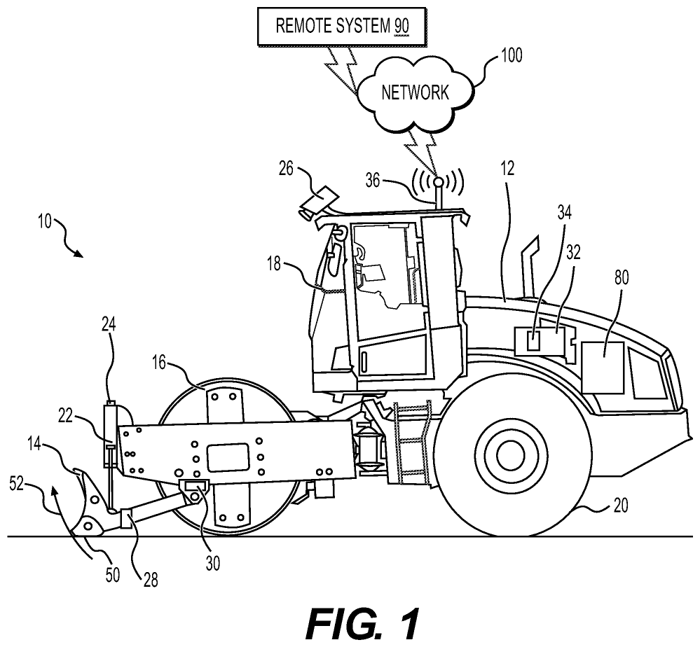

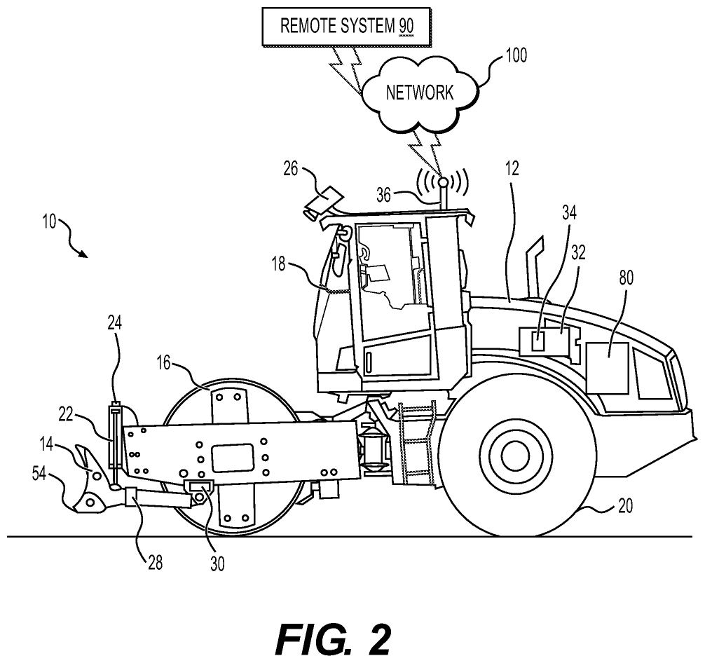

FIGS. 1 and 2 illustrate a machine implement system 10 including features for automating control of an implement 14 of a machine 12, according to aspects of the present disclosure. System 10 may include a remote system 90 in communication with a controller 80 of machine 12 over one or more networks 100. While a soil compacting machine 12 having a controllably-vibrating compacting drum 16 is shown in FIGS. 1 and 2, as understood, machine 12 may include other types of compacting devices having an implement 14 that, when lowered or tilted, can contact the ground. For example, machine 12 may include a plurality of drums 16, one or more drums 16 that do not include vibration functionality, a smooth drum 16 (FIGS. 1 and 2), a drum including tamping feet, etc.

Machine implement system 10 may be configured for fully-autonomous operation, semi-autonomous operation, and/or remote operation of machine 12. As used herein “autonomous” refers to both fully-autonomous and semi-autonomous modes of operation. Semi-autonomous operation includes independent operation of at least one component of machine 12 (e.g., propulsion and steering) while an operator within machine 12 or at a remote location supervises operation of machine 12. The supervising operator may also control one or more aspects of machine 12 during this operation (e.g., a vibration of drum 16), and may override autonomous commands. Fully-autonomous operation may not require supervision such that, in response to receiving a request initiated by an operator, machine 12 may perform a task in a desired work area, such as compacting at least a portion of this area, without further intervention or input from the operator.

Machine 12 may include implement 14, drum 16, a cabin 18, and a ground-engaging traction device 20 (e.g., wheels or tracks). A hydraulic fluid supply system 32 of machine 12 may supply hydraulic fluid to a hydraulic cylinder 22, via one or more hydraulic valves and one or more pumps (not shown), for controllably changing a position of implement 14. Machine 12 may also include an internal combustion engine (not shown), controlled by a machine control unit, such as controller 80.

System 10 may include a perception device 26 (e.g., a camera, laser scanning and/or LiDAR devices, a radar device, Global Positioning System receiver, a Global Navigation Satellite System device, etc.), configured to facilitate autonomous or remote operation, as described below. System 10 may also include one or more devices for monitoring a position of implement 14. These devices for monitoring the position of implement 14 may be in communication with controller 80 and may include, for example, a hydraulic cylinder position sensor 24, an acceleration sensor 28 such as an inertial measurement unit, one or more rotary position sensors 30 that detect a position at joint (e.g., a position of a rotatable linkage), a hydraulic pressure sensor 34 configured to detect a pressure of hydraulic fluid associated with hydraulic fluid supply system 32, and/or other devices. In some aspects, a single one of sensors 24, 28, 30, and 34 may be present for monitoring a position of implement 14. However, in at least one aspect, and as explained below, no sensor may be present for determining the position of implement 14.

System 10 may also include one or more devices for receiving remote commands and for facilitating autonomous operation of machine 12. For example, machine 12 may include a network communication device 36 for communicating with one or more remote systems 90 via network 100, such as the internet. Network communication devices 36 may be configured to receive commands for autonomous operation of machine 12 that are generated by remote system 90 and may provide information regarding a current operating state of machine 12 to the remote system, including a geographic location of machine 12 (e.g., as measured by a Global Positioning System receiver), an operating status of an internal combustion engine of machine 12, a status of implement 14 and drum 16 of machine 12, speed, orientation, and/or acceleration of machine 12, and other appropriate information. Remote system 90 may include one or more computing systems configured to control a plurality of different machines, including a plurality of different types of machines. As such, a single input device of remote system 90 (e.g., a joystick, button, switch, etc.) may perform different functions depending on the type of machine being controlled, autonomously and/or remotely, with remote system 90.

As shown in FIG. 1, implement 14 may be selectively positioned at a ground-engaging or work position 50 at which blade 14 may contact material of a work area, such as soil. This position may be useful for engaging this material in order to change a grade, or slope, of the material, for spreading material while compacting, or for preventing material from accumulating under drum 16. FIG. 2 illustrates implement 14 in a fully-raised position 54 at which blade 14 does not contact the ground. This position 54 may allow machine 12 to compact soil, or other material, without significantly changing the grade of this material. Blade 14 may be raised along direction 52 (FIG. 1) by actuating hydraulic cylinder 22, and lowered by actuating hydraulic cylinder 22 in the opposite direction.

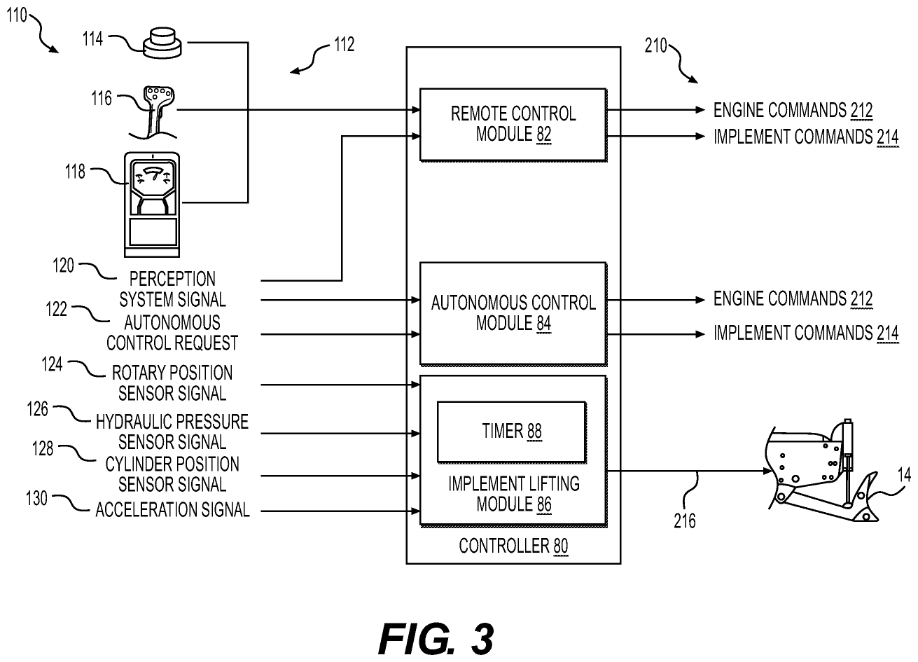

FIG. 3 is a block diagram illustrating an exemplary configuration of controller 80, according to aspects of the present disclosure. Controller 80 may be configured to receive a plurality of inputs 110 indicative of operator requests, sensor or other feedback signals, and other information, and to generate outputs 210 useful for controlling operations of machine 12. Inputs 110 may include one or more signals to facilitate remote control of machine 12 from remote system 90, one or more signals to facilitate autonomous (including fully autonomous and semi-autonomous) operation of machine 12, and, if desired, one or more signals indicative of a current position of implement 14. Controller 80 may be programmed with one or more modules that facilitate operation of machine 12 and intelligent (e.g., automated) raising of implement 14. In an exemplary configuration, controller 80 may include a remote control module 82, autonomous control module 84, and implement lifting module 86. Controller 80 may be configured to generate outputs 210 for controlling operations of components of machine 12.

Operation commands 112 of inputs 110 may include commands generated with remote system 90 for remote control of machine 12, and may include one or more commands generated by interacting with a switch 114, control lever 116, and a display I/O device 118 (e.g., a touchscreen). Operation commands 112 may include a command to selectively enable and disable an intelligent raise mode (or automatic operation mode) for raising implement 14 based on current conditions, as described below. The command for enabling or disabling the intelligent raise mode may be generated by a user's interaction with a physical button (e.g., switch 114), a position or detent of control lever 116, or a soft switch presented via display I/O device 118, such as a graphical element. Operation commands 112 may be generated as requests from an operator of machine 12 to move or propel machine 12 via ground-engaging traction devices 20 (FIG. 1). Operation commands may also be generated as requests from the operator of machine 12 for operating implement 14.

While operation commands 112 may be generated at remote system 90 and received by network communication device 36 (FIG. 1) of machine 12, operation commands 112, including a request to enable or disable the intelligent raise mode, may instead be generated from a switch 114, control lever 116, and/or display I/O device 118 within cabin 18 of machine 12. Thus, each of the above-described requests may be generated by an operator within cabin 18, an operator in a remote operation station (e.g., via a system 90 outside of machine 12), or a combination of the two. As used herein, an “operator” refers to either an operator located physically within cabin 18 or an operator located at a remote location outside of machine 12, such as a remote operation station including one or more remote systems 90 configured to operate a plurality of machines.

Operation commands 112 may also include one or more commands for autonomous operation of machine 12 (e.g., when controller 80 is not configured to generate autonomous commands itself). These commands may be generated by one or more autonomous control systems (e.g., remote system 90) in communication with controller 80. However, controller 80 itself may be configured to autonomously operate machine 12 in response to autonomous control request 122, as described below.

Perception system signal 120 may include one or more signals generated by perception device(s) 26 including, as described above, one or more of a: camera, laser scanning and/or LiDAR device, a radar device, Global Positioning System receiver, a Global Navigation Satellite System device, and others. Perception system signal 120 may be configured to provide a remote operator with a view of machine 12 and of an environment in which machine 12 is operating. Perception system signal 120 may also be indicative of a condition of this work environment. For example, perception system signal 120 may be indicative of a grade of material based on a location of machine 12 and/or by direct measurements of the work material (e.g., soil) in the work environment. In some aspects, perception system signal 120 may allow controller 80 to monitor a position of implement 14. Perception system signal 120 may also include signals from devices 26 that allow an autonomous system to operate by generating commands to propel machine 12 and operate implement 14 and drum 16.

An autonomous control request 122 may correspond to a request signal generated from remote system 90 and received by network communication device 36, or a signal generated from within cabin 18 (e.g., by an operator initiating semi-autonomous operation of machine 12). This request 122 may be generated prior to starting machine 12, or while machine 12 is running. Autonomous control request 122 may be associated with a particular section or area in which machine 12 is requested to compact soil.

Signals 124, 126, 128, and 130 may be generated for monitoring a position of implement 14, such as a blade of a soil compacting machine 12. Rotary position sensor signal 124 may be generated by rotary position sensor 30 for determining a position of a linkage that moves during activation of hydraulic cylinder 22 or another actuator. Hydraulic pressure sensor signal 126 may correspond to a pressure of hydraulic fluid detected by pressure sensor 34 and may be indicative of an activation or deactivation of hydraulic cylinder 22. For example, a peak or spike in hydraulic pressure measured with sensor signal 126 may indicate that the implement 14 is in a fully raised position. Cylinder position sensor signal 128 may be generated by a sensor secured to hydraulic cylinder 22 to indicate a position of a piston of cylinder 22. Acceleration signal 130 may include one or more signals generated by acceleration sensor 28 to monitor changes in position of implement 14.

Remote control module 82 may enable controller 80 to operate in response to remote commands, such as operation commands 112. Remote control module 82 may receive perception system signal(s) 120 in addition to operation commands 112, to allow remote control module 82 to communicate with one or more remote systems 90 (FIG. 1). Remote control module 82 may be configured to generate engine commands 212 and implement commands 214 as outputs, to respectively propel machine 12 and operate implement 14 and/or drum 16 in response to requests from a remote operator.

Autonomous control module 84 may allow controller 80 to perform semi-autonomous or fully autonomous control of machine 12. Autonomous control module 84 may receive perception system signal(s) 120, as described above, as well as an autonomous control request 122. In a semi-autonomous operation, an operator within cabin 18 may generate request 122 for controller 80 to control machine 12. During this operation, the operator may supervise machine 12 and may control one or more functions of machine 12, while machine 12 is autonomously steered and propelled (e.g., by generating engine commands 212, transmission commands, steering commands, etc.). During semi-autonomous operation, implement commands 214 may control a vibration level of drum 16 (e.g., a vibration intensity), and the position of a blade implement 14. During semi-autonomous control, the operator may intervene by manipulating control lever 116, a pedal, or another input device within cabin 18. During fully autonomous control, autonomous control module 84 may generate commands 212 and 214 in response to receiving request 122 to cause machine 12 to operate without an operator present in cabin 18 and, if desired, without an operator supervising via remote system 90.

Implement lifting module 86 may be configured to intelligently (e.g., automatically) raise implement 14 regardless of whether machine 12 is under manual control by an operator within cabin 18, remote control, semi-autonomous control, or autonomous control. Implement lifting module 86 may be in communication with remote control module 82 and autonomous control module 84, or integrated as part of one or both of modules 82 and 84. Module 86 may generate, as an output 210 of controller 80, a lifting command 216 to operate hydraulic cylinder 22 and raise implement 14. This command may actuate a control valve (e.g., a hydraulic valve of hydraulic fluid supply system 32).

In at least some configurations, implement lifting module 86 may be configured to ensure that implement 14 is in a raised position (e.g., at or above a predetermined threshold level or height). While an exemplary raised position may correspond to a fully-raised position (e.g., a maximum height of a blade), the raised position may be any position above a threshold height that is less than a fully-raised position (e.g., a mid-point between a fully-lowered and fully-raised position, 75% of the fully-raised position, etc.). In order to ensure that implement 14 is in a raised position corresponding to a threshold height, or above, implement lifting module 86 may be provided with a timer 88. Timer 88 may produce a clock signal that allows implement lifting module 86 to output a lifting command 216 to raise implement 14 for a predetermined threshold amount of time associated with the threshold position at which, for example, a blade of implement 14, will not contact the ground, even when machine 12 is located facing upward on a slope. In addition to or instead of timer 88, implement lifting module 86 may ensure that implement 14 reaches a raised position by monitoring the height of the blade of implement 14 based on one or more of rotary position sensor signal 124, hydraulic pressure sensor signal 126, cylinder position sensor signal 128, and acceleration signal 130. In configurations where timer 88 is present, sensors 24, 28, and 34 need not be present such that no sensor is monitors the position of implement 14.

In at least some configurations, implement lifting module 86 may be operable to ensure that implement 14 is raised based on a current operating condition of machine 12, a current condition of a work environment of machine 12, or both. In configurations where lifting command 216 is generated based on a condition of machine 12, implement lifting module 86 may generate command 216 each time machine 12 begins to operate (e.g., in response to a startup of machine 12 initiated by an operator or by autonomous control request 122). In some aspects, the condition of the machine may correspond to an operation of the machine in a remote operation mode or an autonomous operation mode. For example, lifting command 216 may be output each time machine 12 begins to be operated in a remote operation mode. If desired, lifting command 216 may be output each time machine 12 begins to be operated in an autonomous operation mode. For example, lifting command 216 may be generated by implement lifting module 86 when operation of machine 12 is initiated based on one or more remote operation commands 112, such as a propulsion command or a command to begin operation of machine 12 (e.g., by starting an engine for powering machine 12). In some aspects, controller 80 may block or delay a request for propulsion (e.g., prevent motion of ground-engaging traction devices 20), until lifting command 216 is output by controller 80 for a predetermined period of time, as determined with timer 88. For example, controller 80 may receive an operation command 112 requesting propulsion of machine 12, but may not permit movement of machine 12 until implement 14 reaches the raised position described above. This blocked or delayed request for propulsion may be a request from a remote operator interacting with remote system 90. Controller 80 may be configured to block or delay a request for propulsion until a sensed position of implement 14 reaches a predetermined threshold level or height, as measured with rotary position sensor signal 124, hydraulic pressure sensor signal 126, cylinder position sensor signal 128, and acceleration signal 130, as described above.

When implement lifting module 86 generates lifting command 216 based on a condition of the work environment, this condition may correspond to a need to perform grading at a current location (e.g., work area) of machine 12, or a condition of material (e.g., presence of loose soil) in the work area. During remote or autonomous operation of machine 12, a location of machine 12 and a state (e.g., grade) of soil associated with the location of machine 12 may be known by the remote system, controller 80, or both, based on perception system signal 120. This information may be determined with historical information associated with the location of machine 12, or real-time or updated information (e.g., from a drone or sensor on machine 12). Thus, implement lifting module 86 may be configured to generate command 216 to automatically raise implement 14 in response to a determination that material in a vicinity (e.g., immediately in front of) machine 12 has a desired grade. This may prevent altering a grade of material in the work area of machine 12, preventing the need for rework.

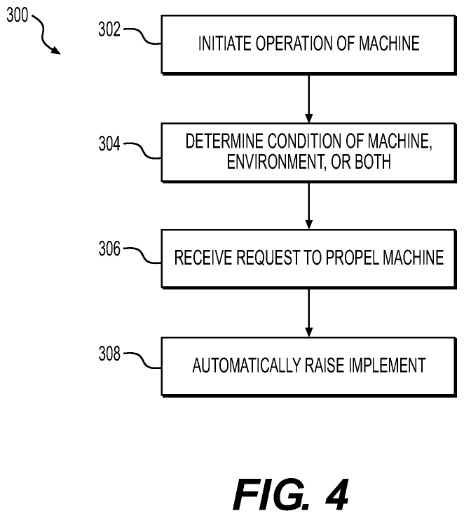

Controller 80 may include or embody a single microprocessor or multiple microprocessors that receive inputs (e.g., inputs 110) and issue control signals or other outputs (e.g., outputs 210). Controller 80 may include a memory, a secondary storage device, a processor such as a central processing unit, or any other means for accomplishing a task consistent with the present disclosure. The memory or secondary storage device associated with controller 80 may store data and software to allow controller 80 to perform its functions, including each of the functions described with respect to method 300 (FIG. 4). In particular, such data and software in memory or secondary storage device(s) may allow controller 80 to perform the functions associated with remote control module 82, autonomous control module 84, and implement lifting module 86. Numerous commercially available microprocessors can be configured to perform the functions of controller 80. Various other known circuits may be associated with controller 80, including signal-conditioning circuitry, communication circuitry, and other appropriate circuitry.

### INDUSTRIAL APPLICABILITY

Machine implement system 10 may be used in conjunction with compacting machines and, in particular, compacting machines configured for remote operation, autonomous operation, or both. Machine implement system 10 may be used to facilitate control of one or an implement, such as a blade, to prevent inadvertently engaging material, for example soil, with the implement. A request to initiate autonomous operation of machine 12 may be received as autonomous control request 122, prior to or following start-up of machine 12. Additionally or alternatively, controller 80 may receive operation commands 112 for operating machine 12, from an operator located within cabin 18, or from a remote system 90. Controller 80 may be configured (e.g., programmed) with an implement lifting module 86 that monitors a condition of machine 12 and/or of the environment (e.g., a grade of soil), and automatically raises implement 14, when necessary, during remote operation, autonomous operation, and, if desired, manual operation.

FIG. 4 is a flowchart illustrating an exemplary process 300 performed with machine implement system 10 for automatically raising an implement 14, such as a blade of a soil compactor. In a step 302, operation of machine 12 may be initiated. Step 302 may include starting an internal combustion engine or other power-generating device of machine 12 in response to an operation performed within cabin 18, or in response to a remote command. In some configurations, step 302 may include initiating operation of machine 12 in response to receiving an autonomous control request 122 from a remote system 90 or from an input device within cabin 18.

Step 304 may include determining a condition of machine 12, a condition of the work environment, or both. The condition of machine 12 may include a mode of operation of machine, including a remote operation mode and an autonomous operation mode. The condition of machine 12 may be determined based upon receipt of remote operation commands 112 or autonomous control request 122. If desired, the condition of machine 12 in step 304 may also include a position of implement 14, based on sensor signals 124, 126, 128, and/or 130. When a condition of a work environment of machine 12 is determined based on a location of machine 12, this information may indicate a current grade of one or more areas of material proximate to machine 12 and a difference between this current grade and a desired grade. Current grade information may be determined based on perception device(s) 26, such as laser scanning and/or LiDAR devices, a radar device, Global Positioning System receiver, a Global Navigation Satellite System device, etc. Desired grading information may be determined from an operator of remote system 90. When the current grade is the same as or approximately the same as the desired grade, for example, this information may form the basis for raising implement 14 in step 308 described below. Additional information regarding the condition of the work environment may include the presence of a particular type of material (e.g., loose soil) that is provided based on historical information of the work environment or information received from a remote or on-site operator.

Step 306, which may be optionally performed, may include receiving a request to propel machine 12. This request may be a manual request received from operation commands 112 within cabin 18, or remotely-received operation commands 112 that are obtained via network communication device 36. Step 306 may include a determination, by autonomous control module 84, that propulsion of machine 12 is desired. This determination may be made based on autonomous control request 122, for example. In some aspects, controller 80 may be configured to block the request to propel machine 12, and thereby prevent or delay propulsion of machine 12. For example, implement lifting module 86 may block a propulsion request from remote system 90, or otherwise prevent propulsion of machine 12 to allow sufficient time for lifting command 216 to ensure that implement 14 is raised, after which machine 12 is permitted to be propelled forward.

Step 308 may include automatically raising implement 14 by outputting lifting command 216 to actuate hydraulic cylinder 22, for example. Step 308 may be performed based on the condition determined in step 304 and/or in response to receipt of the request to propel machine 12 received in step 306. Step 308 may include generating lifting command 216 based on a determination that machine 12 is being operated remotely or autonomously. If desired, lifting command 216 may be generated every time operation of machine 12 is initiated and before the machine 12 is propelled. In another example, lifting command 216 may be generated based on a determination that it would not be desirable to modify a grade of material in the work environment. Thus, it may be possible for controller 80 to permit propulsion of machine 12 to simultaneously grade and compact one or more first passes of the work environment, and subsequently automatically raise implement 14 to compact, without grading, the same portion of material during one or more second passes of the work environment. In step 308, command 216 may be output for a predetermined period of time based on timer 88. This period of time may be sufficient to raise implement 14 to the fully-raised position (e.g., as shown in FIG. 2).

If desired, the position of implement 14 may be known and monitored based on rotary position sensor signal 124, hydraulic pressure sensor signal 126, cylinder position sensor signal 128, and/or acceleration signal 130, as described above. In such examples, step 304 may include determining the position of implement 14, and step 308 may be performed based on a determination that the position of implement 14 is below the predetermined threshold level or height described above. Additionally, while a soil compactor having a drum 16 and blade 14 is shown in the drawings and described above, it is apparent that aspects of the present disclosure may be applicable to machines having different types of ground-engaging implements, including machines other than compactors.

Automatic generation of a blade raising command may facilitate use of various machine systems, such as compactors that are useful for modifying a grade of material, spreading material, or to prevent material accumulation. In some systems, an implement may be raised without the need to supply position feedback of the implement to a controller, reducing complexity of the system. Automatically raising an implement may prevent the need to perform rework when a grade of material is inadvertently modified. Errors may also be avoided when performing remote operation of the machine in which visibility may be significantly reduced as compared to in-cabin operation. Additionally, autonomous operation may be improved by ensuring that an implement is raised, for example, prior to initiation of autonomous propulsion.

It will be apparent to those skilled in the art that various modifications and variations can be made to the disclosed method and system without departing from the scope of the disclosure. Other embodiments of the method and system will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A method for control of a compacting machine including a ground-engaging implement and a compacting drum, the method comprising:
receiving a request to activate the compacting machine;
receiving a command to propel the compacting machine;
automatically generating a command to move the implement to a raised position in which the implement does not engage the ground based on: the request to activate the compacting machine, the command to propel the compacting machine, or a determination that the implement is below a threshold height; and
once the implement is in the raised position, propelling the compacting machine.

2. The method of claim 1, wherein the command to move the implement to the raised position is generated based on the request to activate the compacting machine.

3. The method of claim 2, wherein the request to activate the compacting machine is a request for autonomous operation of the compacting machine.

4. The method of claim 1, wherein the command to move the implement is generated based on a remotely-generated request to activate the compacting machine or a remotely-generated command to propel the compacting machine.

5. The method of claim 1, wherein the command to move the implement to the raised position is performed based on a condition of a work area of the compacting machine.

6. The method of claim 5, wherein the condition of the work area is a grade of material in the work area.

7. The method of claim 1, wherein propelling the machine is performed subsequent to a request for an automatic operation mode of the implement generated by interacting with a switch, a control lever, or a graphical element of a display device.

8. The method of claim 7, wherein automatic operation of the implement is performed each time the machine is initiated while the automatic operation mode is enabled.

9. The method of claim 1, wherein the command to move the implement to the raised position is generated for a predetermined amount of time.

10. The method of claim 9, wherein the command to move the implement to the raised position causes a hydraulic valve to actuate a hydraulic cylinder to bring the implement to a fully raised position.

11. The method of claim 1, further including delaying a command to propel the machine until the implement reaches the raised position.

12. The method of claim 1, wherein the command to move the implement to the raised position is generated based on the determination that the implement is below the threshold height, according to a signal generated by a perception device, a signal indicative of a position of the implement, or a hydraulic pressure signal.

13. A method for control of an earthmoving machine including an implement and a compacting drum, the method comprising:
receiving a request for the machine to perform a task, the request being: received from a remote system outside of the machine, a request for autonomous operation of the earthmoving machine, or both;
in response to the request, automatically generating a command to move the implement to a raised position in which the implement does not engage ground, the command being generated for a predetermined amount of time; and
propelling the earthmoving machine, once the implement is above the ground.

14. The method of claim 13, further including delaying a request to propel the earthmoving machine generated with the remote system until the implement is in the raised position.

15. The method of claim 13, wherein the request is a request for autonomous operation of the earthmoving machine.

16. A compacting machine, comprising:
a cabin;
a compacting drum;
a blade configured to be selectively positioned at a lowered position in which the blade is configured to engage material and a raised position above the material; and
a controller configured to:
receive a command to propel the compacting machine,
automatically generate a command to move the blade to the raised position in which the blade does not engage ground based on: an activation of the compacting machine, the command to propel the compacting machine, or a determination that the blade is below a threshold height, and
once the blade is in the raised position, generate a command to propel the compacting machine in an autonomous mode or a remote operation mode.

17. The compacting machine of claim 16, wherein the controller is further configured to automatically generate the command to move the blade based on the activation of the compacting machine.

18. The compacting machine of claim 16, wherein the controller is configured to automatically generate the command to move the blade in response to entering an autonomous operation mode in which the command to propel the compacting machine is generated automatically.

19. The compacting machine of claim 16, wherein the controller is configured to automatically generate the command to move the blade when automatic operation of the blade is requested via a switch, a control lever, or by interacting with a graphical element of a display device.

20. The compacting machine of claim 19, wherein the controller is configured to generate the command to move the blade to the raised position for a predetermined amount of time.
